(19) United States
(12) Patent Application Publication
(10) Pub. No.: US 2022/0318320 A1
(43) Pub. Date: Oct. 6, 2022

(54) FOCUSED WEB CRAWLING SYSTEM AND METHOD THEREOF

(71) Applicants: Rajesh Kumar Bhatia, Chandigarh Sector 12 (IN); Manish Kumar, Chandigarh Sector 12 (IN); Kashish Bhatia, Punjab (IN)

(72) Inventors: Rajesh Kumar Bhatia, Chandigarh (IN); Manish Kumar, Chandigarh (IN); Sanjeev Sofat, Chandigarh (IN); Sanjay Batish, Chandigarh (IN); Pardeep Kumar, Jalandhar (IN); Kapil Madan, Chandigarh (IN); Kashish Bhatia, Punjab (IN)

(21) Appl. No.: 17/356,619

(22) Filed: Jun. 24, 2021

(30) Foreign Application Priority Data
Apr. 1, 2021 (IN) 202111015573

(51) Int. Cl. G06F 16/951

(52) U.S. Cl. CPC G06F 16/951

(57) ABSTRACT

The present invention relates to a system for focused web crawling comprising a crawler, a distiller, a queuing unit and a classifying module arranged to undergo a method for focused web crawling that inputs a seed address into a subsequently formed address queue, iteratively extracts a primary address from the address queue, iteratively invigilates the primary address for presence in an address store, and follows a series of steps to conduct relevancy check of the addresses via naive bayes protocol, simultaneously calculates primary conditional probability of a set of predefined webpage(s) using the protocol, sequentially calculates plurality of secondary conditional probabilities pertaining to the webpage(s) of the iteratively extracted primary addresses, further classifies the webpage(s) as relevant/irrelevant webpage(s) and finally transfers addresses of the relevant webpage(s) and the relevant set of addresses into the address queue, else into the address store.

### STATEMENT REGARDING DEPARTMENT OF SCIENCE AND TECHNOLOGY (DST) SPONSERED RESEARCH PROJECT

The invention was made with government of India support and is funded by Department of Science and Technology Government of India. The end product in the form of Management Information System (MIS) that shall showcase the achievements of Indian scientists and academicians working abroad and highlighting achievements of Indian women scientists and academicians. The resulting database shall also be useful to scientific community and other stakeholders in forging research and academic collaborations, policy planning, etc.

### FIELD OF THE INVENTION

The present invention relates to the field of web crawlers systems. More specifically, present invention relates to a focused web crawling system and method that ensures fetching of user-desired content only through efficiently derived scrutiny of webpages and addresses linked thereto.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

To effectively use the vast amount of information available online, webpages that comprise World Wide Web (WWW) need to be classified. Webpage classification is essential not only to satisfy knowledge growth of academics but also required to provide quick and efficient solutions of information analysis for industry. According to a survey conducted by Global Growth Markets (GGM) and commissioned by Elsevier (National Diet Library 2011), nine out of ten doctors in Asia-Pacific rely on online search engine to aid clinical decisions.

CN106294364B discloses a method and device for realizing web crawler to capture web pages. The method comprises the steps that web pages belonging to different websites are divided into different web page clusters in advance, and/or web pages belonging to different products in the same website are divided into different web page clusters; the method comprises the following steps: for any webpage cluster, counting a minimum confidence interval of the sleep time of the webpage cluster during capturing when the capturing success rate of the webpage cluster meets a preset confidence level; configuring the sleep time of the webpage cluster during capturing within the minimum confidence interval range; and informing the configured sleep time to the web crawler so that the web crawler captures the web pages in the web page cluster according to the configured sleep time. Through the method and the device, the problem that the capturing success rate and the capturing efficiency cannot be effectively guaranteed simultaneously when the web pages in different websites or the web pages of different products in the same website are captured in the prior art can be solved. The embodiment of the application also discloses a device for realizing web crawler to capture web pages.

Moreover, Google, a general purpose search engine, is the most popular and non-evidence based search engine used by doctors. Moreover, by 2022, in every 73 days, the medical knowledge will double in volume. The biggest disadvantage of such general purpose search engine is that the domain with information is to be fetched is very large. Hence the collection of webpages they return contains a lot of irrelevant data as well.

Focused web crawling systems and methods can be a solution to such problems, wherein the focused crawler decides which URLs to explore to reach webpages of interest. Deciding the relevancy of a webpage in accordance with a topic of interest can be considered as a supervised learning problem. Binary classifiers are used to take the decision, whether a webpage is relevant or irrelevant according to topic of user interest. Therefore a set of pre-downloaded webpages can be used as a training example set for classifier to make future decision easy.

Hence, there is a need to envision a focused crawling system and method that can search webpages by the topics and can index the webpages of interest instead of gathering all the webpages, thereby acquiring only user-desired webpages adaptively, accurately and speedily.

### OBJECTS OF THE INVENTION

The principal object of the present invention is to overcome the disadvantages of the prior art.

An object of the present invention is to provide a web crawling system and method that adaptively acquires only relevant pages of interest, thus executing focused web crawl.

Another object of the present invention is to provide a web crawling system and method that efficiently implements one or more advanced filtering techniques onto web addresses, thereby retaining only relevant ones.

Another object of the present invention is to provide a web crawling system and method involving an advanced probabilistic classification criteria for scrutinizing webpages and addresses thereof.

Yet another object of the present invention is to provide a web crawling system and method that makes efficient use of trie data structure to conduct keyword matching of webpages and verification of addresses linked thereto, thus facilitating fast web crawling.

The foregoing and other objects, features, and advantages of the present invention will become readily apparent upon further review of the following detailed description of the preferred embodiment as illustrated in the accompanying drawings.

### SUMMARY OF THE INVENTION

The present invention relates a web crawling system and method that facilitates user-defined scrutiny of webpages and addresses of the webpages through execution of multiple filtering techniques and an advanced probabilistic classification criteria, thereby delivering user desired web results.

According to an embodiment of present invention, the system for focused web crawling comprises a crawler configured to extract addresses of plurality of webpages similar to a receivable at least one seed address, a distiller configured to sequentially refine the addresses using plurality of filtration techniques and naïve bayes protocol, thereby transferring a first set of relevant addresses for being iteratively passed onto the crawler and a classifying module operable to categorize the plurality of webpages for relevancy via the protocol, thereafter deriving a second set of relevant addresses for being iteratively passed onto the distiller.

According to another embodiment of present invention, the crawler retrieves the plurality of webpages as well as addresses associated with the plurality of webpages, the system further comprises of a queuing unit for maintaining at least one list of the addresses extracted from the crawler, the queuing unit strategically updates the list based on sequential inputs received from the crawler, the classifying module formulates an intelligence matrix from a training unit configured to conceptualize the relevancy and the training unit further includes a keyword extraction unit containing a list of keywords to be analyzed therein for the conceptualization.

According to another embodiment of present invention, the front address from the first set of relevant addresses is passed onto the crawler. According to another embodiment of present invention, the crawler also maintains a crawling history that includes but not limited to crawled part of the plurality of webpage, time taken to download a file, number of the iterations. According to another embodiment of present invention, the plurality of filtration techniques are selected to be but not limited to checking top level domain of the addresses, checking no out of domain address, checking duplicity in already processed addresses, checking duplicity in yet to be processed addresses, discarding addresses based on irrelevant keywords.

According to another embodiment of present invention, the training unit conducts procedures including but not restricted to stopword elimination, stemming, generation of set of features based on occurrence frequency, implementation of the naïve bayes protocol. According to another embodiment of present invention, the training unit further shortlists the set of features using approaches including but not limited to document frequency approach, information gain approach, chi-square statistics approach, term strength approach. According to another embodiment of present invention, the classifying module categorizes the plurality of webpages by comparing the intelligence matrix.

The present invention also relates to a method to implement focused web crawling, comprising steps of inputting a seed address into a subsequently formed address queue, iteratively extracting a primary address from the address queue, iteratively invigilating the primary address for presence in an address store, wherein if not present, extracting set of secondary addresses from webpage of the primary address, applying plurality of filtering techniques as a passing criteria on the set of secondary addresses, wherein if passed, verifying the set of secondary addresses for presence of a set of predefined keywords, upon successful verification, classifying the set of secondary addresses for relevancy via naive bayes protocol, transferring relevant set of secondary addresses into the address queue, else into the address store, simultaneously calculating primary conditional probability of a set of predefined webpage(s) using the protocol, sequentially calculating plurality of secondary conditional probabilities pertaining to the webpage(s) of the iteratively extracted primary addresses, classifying the webpage(s) having the secondary conditional probability higher than the primary conditional probability as relevant webpage(s), else irrelevant webpage(s) and transferring addresses of the relevant webpage(s) into the address queue, else into the address store.

According to an embodiment of present invention, the primary address is preferably front address in the address queue. According to another embodiment of present invention, the plurality of filtration techniques are selected to be but not limited to checking top level domain of the addresses, checking no out of domain address, checking duplicity in already processed addresses, checking duplicity in yet to be processed addresses, discarding addresses based on irrelevant keywords.

According to another embodiment of present invention, calculation of the secondary conditional probability is supported by plurality of preliminary procedures including but not restricted to stopword elimination, stemming, generation of set of features based on occurrence frequency. According to another embodiment of present invention, classification of the relevant set of secondary addresses and addresses of the relevant webpage(s) occurs concurrently.

While the invention has been described and shown with particular reference to the preferred embodiment, it will be apparent that variations might be possible that would fall within the scope of the present invention.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

In the figures, similar components and/or features may have the same reference label. Further various components of the same type may be distinguished by following the reference label with a second label that distinguishes among the similar components. If only the first reference label is used in the specification, the description is applicable to any of the similar components having the same reference label irrespective of the second reference label.

FIG. 1 illustrates a schematic diagram of a focused web crawling system, according to an embodiment;

FIG. 2 illustrates a block diagram of a training unit configured to formulate an intelligence matrix used as a reference for assessing relevancy of webpages, according to an embodiment;

FIG. 3 shows a flow chart of a sequence of steps carried out in a classifying module, according to an embodiment;

FIG. 4 illustrates a flow chart of a focused web crawling method executed to classify webpages and addresses of webpages, according to an embodiment;

FIG. 5 illustrates a flow chart of a concurrently executed second part of the focused web crawling method for classification of webpages, according to an embodiment;

FIG. 6A shows experimental performance chart of precision verses true positive for disclosed naïve bayes protocol in comparison to other state-of-the art protocols, according to an embodiment; and

FIG. 6B shows experimental performance chart of harvest ratio verses retrieved webpages for disclosed naïve bayes protocol in comparison to other state-of-the-art protocols, according to an embodiment.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Various terms as used herein are shown below. To the extent a term used in a claim is not defined below, it should be given the broadest definition persons in the pertinent art have given that term as reflected in printed publications and issued patents at the time of filing.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The present invention relates to a focused web crawling system and method that employs naïve bayes protocol based classification supplemented with advanced filtering techniques to adaptively and accurately acquire user desired web crawling results only.

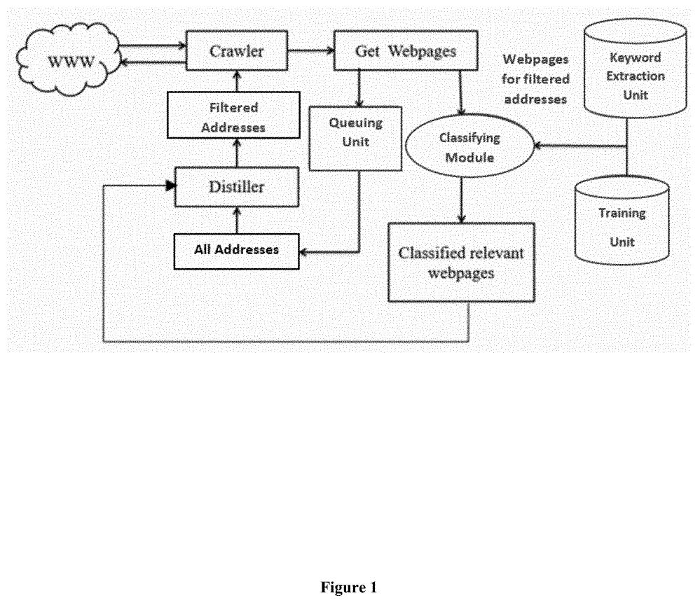

Referring to FIG. 1, a schematic diagram of the disclosed system architecture is shown that comprises of a crawler, a distiller, a classifying module, a queuing unit, a training unit and a keyword extraction unit. The seed address is the starting address for the iterations being performed by the crawler. World Wide Web is a collection of unlimited number of webpages of different domains. Plurality of webpages can be retrieved and addresses thereof can be extracted from those retrieved plurality of webpages.

The queueing unit is used to store and thus maintain at least one list of addresses found by the crawler, wherein the unit strategically updates the list based on sequential inputs received from the crawler. The distiller refines the extracted addresses using plurality of filtration techniques and naïve bayes protocol, thereby transferring a first set of relevant addresses for being iteratively passed onto said crawler. Distiller makes a probabilistic decision of which addresses need to be explored further to reach relevant webpages. These filtered addresses are repeatedly given as input to the crawler to further explore the webpages. Once a webpage is extracted, naïve bayes protocol conducts a relevancy check to classify them as relevant or irrelevant, thereafter deriving a second set of relevant addresses for being iteratively passed onto the distiller. Whilst both distiller and classifier adopt naïve bayes Protocol, the former classifies the addresses only and the later classifies the addresses only.

The crawler receives seed addresses as input to reach the target webpages. The queuing unit stores all the addresses extracted by the crawler. These extracted addresses are given as input to the distiller to refine the addresses that need to be explored further. During each iteration, preferably the front address from the filtered address's queueing unit can be removed and passed to the crawler. The addresses in the queueing unit simply use first in first out rule. Duplicate addresses in the address queue are not added as this is presented by the distiller.

Moreover, crawler sends a hypertext transfer protocol (HTTP) request and reads the response, hypertext transfer protocol client also sets a timeout to handle non-responsive web servers. During the implementation robot exclusion protocol is also considered to follow the server provided access policies. The crawler also maintains a crawling history that includes but not limited to crawled part of the plurality of webpage, time taken to download a file, number of the iterations. This is done to get an insight into a process for future improvement of the crawling process.

According to an embodiment of present invention, the distiller is employed to discard highly irrelevant addresses through plurality of filtering techniques and naïve bayes protocol as well. Herein, a “Highly irrelevant” address means those addresses that can move the crawler into a section of website which will increase the overall distance of current webpage to relevant webpage. Firstly, the filtration techniques can be applied to plurality of addresses to decide highly irrelevant addresses and thereafter naïve bayes protocol can be used to filter them further. The filtration techniques employed by the distiller are selected from but not limited to checking top-level domain of the addresses, checking no out of domain address, checking duplicity in already processed addresses, checking duplicity in yet to be processed addresses, discarding addresses based on irrelevant keywords. A detailed explanation of the filtering techniques is provided below:

a) Checking the top level domain of addresses: To avoid out of domain addresses, the top Level Domain (TLD) of the addresses is checked and matched with the TLD of the seed address. As an example, the seed address www.stanford.edu as TLD as “edu”. So any address whose TLD is different from “edu” will be discarded, thus helping save a lots of resources.
b) No out of domain Address: There may be two or more universities having “.edu” as TLD but may represent completely different website. If crawler is allowed to follow the addresses of same TLD, even then it can be an exhaustive process. So after applying TLD this domain filter will keep the crawler in same domain as that of seed address.
c) Checking duplicity in already processed addresses: For already processed addresses, even after checking for TLD and restricting crawler to the domain of seed address, there can be multiple paths leading to a single webpage on a website. So a check is kept by distiller to find if the address is already been processed or not.

A trie data structure is maintained by distiller for this filter. Trie is used because it is very efficient to search strings having common prefixes in the trie. Trie can also be used for matching string in the dictionary that is used specifically in our project implementation. Frequently used hash table is avoided here for two reasons: First, hash table cannot be used for prefix based search and second, it takes more space than trie data structure.

The use of trie data structure can provide test searching of an address. Using trie, the search complexities can be brought to an optimal limit that is the length of address to be searched. Mathematically, if N is the number of addresses present in the trie and M is the length of the address to be searched, then the complexity of searching is O(M), rather than O(N*M).

d) Checking duplicity in yet to be processed addresses: This is for the case in which if an address is found and saved in an address queue waiting to be processed. The crawler may find multiple instances of the same address and add all the instances to the address queue. So before adding any address to the address queue, another trie is maintained that contains all the addresses which were once added to address queue. This will ultimately avoid reprocessing storing multiple instances in the address queue that may lead to memory overflow for large websites.
e) Discarding addresses but on irrelevant keywords: The addresses are further checked for some keywords that are used to mark the address as irrelevant. The presence of these keywords is checked in the address text itself and also in the text of address to webpage. Depending upon topic of item set of a crawler, addresses are discarded.

The working of classifier and distiller can be divided into two main steps: training and classification. In training phase, a training unit is created by domain expert that consists of webpages classified as relevant or irrelevant and an Intelligence Matrix is derived that defines the features of on-topic webpages.

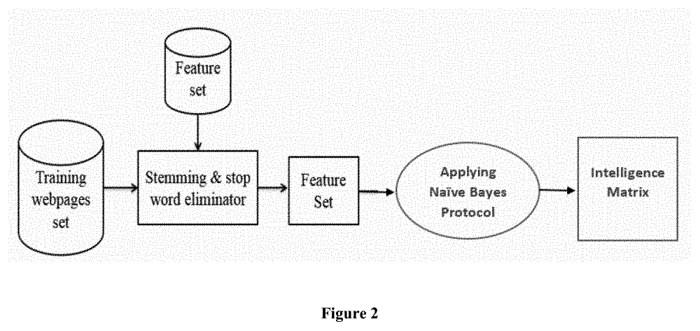

As indicated in FIG. 2, a training set for the classifier is shown, configured to formulate an intelligence matrix used as a reference for assessing relevancy of webpages. The webpages in training repository are preprocessed to eliminate stopwords, for example a, an, for, the, etc. and furthered by stemming procedure. In stemming, root word of the stem words can be determined. Then a keyword set is used to create a feature set based on frequency of occurrence of these keywords in the webpages and position on webpage. In the end, Naïve Bayes Protocol calculates probability of belongingness of a webpage to a user-desired topic, thus producing a feature set with corresponding probabilities that can be used before classification. The output of training unit is an Intelligence Matrix that is used by the classifying unit.

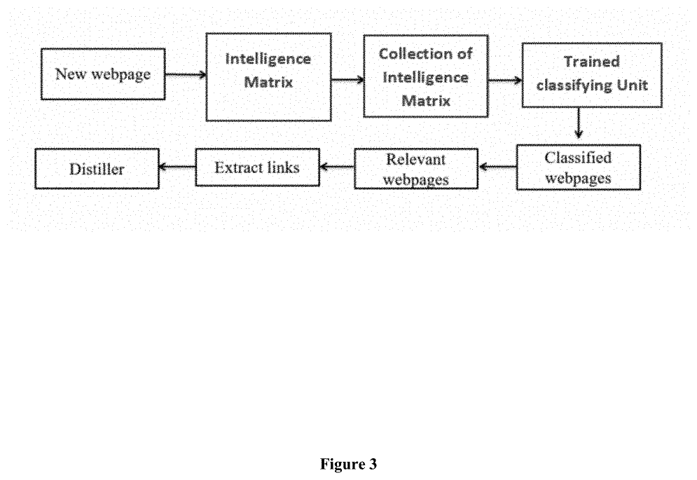

Referring to FIG. 3, a flow chart of a sequence of steps carried out in a classifying module is presented. Herein, stemming and stop-word elimination is performed on webpage text. The input to this trained classifier is an Intelligence Matrix for the webpage whose fate is to be decided. To calculate the required matrix, firstly, the number of occurrences of each word in the document can be counted. The Intelligence Matrix is given as input to the trained classifier that further estimates the probability of webpages to be relevant or irrelevant, thereafter deriving a second set of relevant addresses for being iteratively passed onto said distiller. Similar training and classification phases are carried out by distiller that classifies the addresses as relevant or irrelevant.

According to an embodiment of present invention, time taken by the algorithm to decide relevancy of a webpage depends highly on the feature space. Hence, the training unit further shortlists the set of features using approaches including but not limited to document frequency approach, information gain approach, chi-square statistics approach, term strength approach.

In an aspect, Document Frequency (DF) approach has been found to be most suitable and thus chosen for the study. The DF uses the assumption that terms which occur rarely on webpage are either non-informative for relevance prediction or they do not influence global performance of classifier. So, both cases support removal of rare terms to reduce the dimensionality of feature space. DF is a simple and scalable technique. For each unique term in the training unit, DF is computed and those terms were removed from feature space whose document frequency is less than predefined threshold.

The Basic Naive Bayes protocol is given by:

$$P ( C \vert X ) = \frac{P ( X \vert C ) . P ( C )}{P ( X )} \qquad ( 1 )$$

Wherein, Cᵢ is the class in which webpages are to be classified i∈{0,1} where 0 denotes relevant set of sample data and 1 denotes irrelevant and X is the feature set of one sample data. P(C|X) denotes the conditional probability for webpage X to be relevant when knowing X. Also, P(X) can be ignored because it remains constant for one X ∀C. So, above equation (1) can be rewritten as:

P(C|X)∞P(X|C)·P(C)

P(C) is calculated based on training webpage dataset. P(C) denotes total number of training data set and, for n selected features,

$$P ( \frac{X}{C} ) = P ( \frac{{X}_{1}}{C} ) . P ( \frac{{X}_{2}}{C} ) . P ( \frac{{X}_{3}}{C} ) … P ( \frac{{X}_{n}}{C} ) \qquad ( 2 )$$

In general, equation (2) becomes

$${\prod }_{i = 1}^{n} P ( \frac{{X}_{i}}{C} )$$

Thus, the probability of a feature set belongs to a relevant webpage is decided as:

$$P ( {X}_{j} \vert C ) = \frac{1}{\sqrt{2 π {σ}_{x , c}^{2}}} {e}^{- \frac{1}{2} * [ \frac{{( {x}_{j} - {μ}_{x , c} )}^{2}}{{σ}_{x , c}^{2}} ]}$$

$$Where {μ}_{x , c} = \frac{1}{{n}_{1}} \sum {X}_{j} ( {∀}_{j} : {y}_{j} = c )$$

$${σ}_{x , c}^{2} = \frac{1}{{n}_{1}} \sum {( {x}_{j} - {μ}_{x , c} )}^{2} ( {∀}_{j} : {y}_{j} = c )$$

Where n₁ is number of instances of c in y.

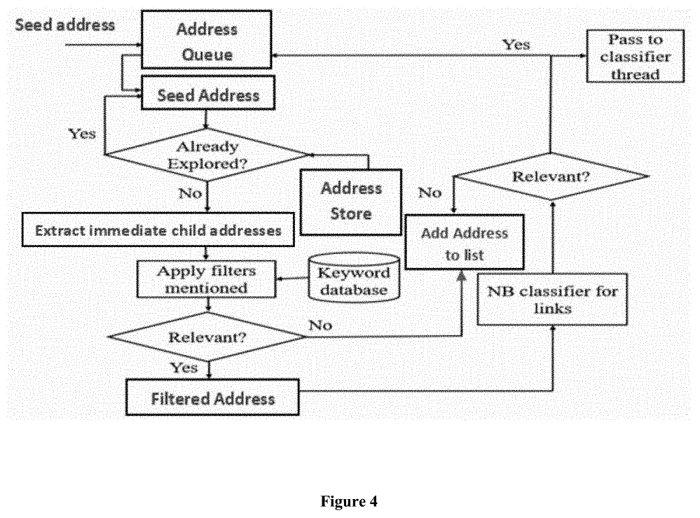

Referring to FIG. 4, a flow chart of a focused web crawling method is shown that is executed to classify webpages and the addresses of the webpages. Seed address is the address that recommends the webpage of interest to the crawler which is to be explored. The primary address, which is basically the front address in the address queue can be extracted and added to a variable parent address and its presence is searched in the address store. If the address is present, then the same step is repeated until we find an address that has not been explored. Upon finding such an address, all the addresses on the webpage of primary address, referred to as the set of secondary addresses, are extracted for further processing. The secondary addresses represent the textual data that is displayed on a webpage, clicking on which redirects the user to a new address or webpage. All the afore-discussed filtering techniques are applied as a next stage passing criteria of said set of secondary addresses.

Subsequently, upon passing the aforementioned criteria, the set of secondary addresses can be verified for presence of a set of predefined keywords, in accordance with the topic of interest. Upon successful verification, the set of secondary addresses are classified for relevancy via naive bayes protocol. If found relevant, the address is added to the address queue and the whole method is repeated again. However, if the address is found to be irrelevant, it is added to the address store.

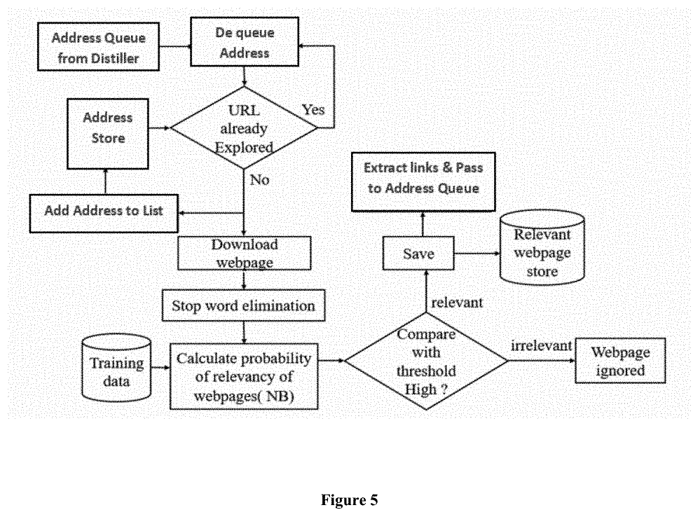

Referring to FIG. 5, concurrently, the classifying unit performs another method and a flow chart of a concurrently executed second part of the focused web crawling method for classification of webpages are shown. The method involves a training phase and a classification phase. In the training phase, the primary conditional probability of a set of predefined webpage(s) is calculated using the Naïve Bayes Protocol as provided in equation 3. |V| is the size of vocabulary and Wₜ is anyone word in V. |D| is the number of training webpages, N is the number of times w appears in webpage Zᵢ. The value of P(C|Zᵢ)=1 when Zᵢ belongs to category C, otherwise, its value is zero.

In the classification phase, the primary addresses from the front of address queue are extracted and check for presence in address store. If not present, we proceed to the next step of classification of the webpage Wₜ. This is performed by calculating plurality of secondary conditional probabilities pertaining to the webpage(s) of said iteratively extracted primary addresses. More specifically, the conditional probability P(Cₖ|Zₜ) for webpage Zₜ belongs to the category Cₖ knowing webpage Zₜ. In this step, Nₜᵣ is the number of times r appears on webpage Zₜ, R represents all distinct words in webpage Zₜ. Finally, the addresses of the relevant webpage(s) are transferred to the address queue, else into the address store.

To empirically study the performance of our proposed algorithm, we used our algorithm for extracting Indian origin academicians from foreign university websites. The persons skilled in the art would appreciate the fact, that in this case study, academicians of Indian nationality are considered but the proposed approach can be applied to any nationality, given the proper datasets used in the methodology. The analysis can be accomplished on Intel Xenon hexacore processor E5620, clock cycle 2.40 GHz with 20 GB RAM running Windows Server 2012 R2 standard.

The Seed address for the crawler is taken as the address of the university from where Indian academicians are to be explored. Around 5800 seed addresses from 26 different countries have been collected. 260 websites from 26 countries (10 from each country) are analyzed manually and two common major structure patterns are analyzed. Firstly, each website contains various sections such as academics, academicians, campus life, events, etc. Each of these sections further contains classified subsections. These subsections further contain more classified subsections and so on. Secondly, the target academician webpages are found under the academic section (or subsection) of website in a classified manner. Example: The academicians of computer science department of a university are expected to be found under computer science department section (or subsection) of the website. Considering this structure of the website, the crawler needs to identify these sections or subsections of website.

To keep the direction of crawling towards relevant webpages, all the afore-discussed filtering techniques are applied. Checking addresses for irrelevant keywords also reduce the chances that crawler does not move in a direction where the chances of getting academician webpages are low. After analyzing 260 websites from different countries, a list of keywords was prepared that represents the section (or subsection) of website that does not have academician relevant data. These keyword lists contain words like “news”, “events”, “syllabus”, “timetable”, “scholarship”, “download” etc. For every secondary address found, presence of the aforesaid strings in text portion thereof is checked and if any such keywords are found, the secondary address and corresponding primary address are discarded.

Upon passing all the filtering techniques, the relevancy of address is judged by naïve bayes protocol based classifier. The training data used for this classification is a labeled dataset that consists of two keyword datasets.
1) Academic keyword set: It consists of those keywords that point to those section/subsection of university website where the chance of finding academicians are high. This contains an exhaustive list of keywords, department names, academic section of the university. This database consists of around 27 disciplines that were used for the training of the distiller.
2) Irrelevant keyword set: This set consists of keywords that are common in university website but moves the crawlers further away from the target academicians' webpage. For example campus map, event, syllabus, etc.

These two databases used by the distiller were updated continuously with time. Referring to FIG. 4, the relevancy is checked in the end by Naïve Bayes Protocol for set of secondary addresses and if found relevant it is passed to the address queue, else added to address store. This is maintained to avoid visiting the same address multiple times. The important features of the text of the secondary addresses are found using intelligence matrix and set to a proper format for categorizing the addresses as relevant or irrelevant.

The filtered URLs are passed onto the classifying unit for deciding if corresponding webpage is an Indian origin academician webpage or not. Two types of webpages have been identified:
A central academician webpage which contains a secondary address to dedicated academician webpage.
A dedicated academician webpage that contains information about a single academician.

The algorithm extracts both types of webpages. The webpages are processed as a separate thread by the system. After analyzing several central and dedicated academician webpages, it is observed that it has high probability that primary and secondary address sets of most of dedicated academician webpages contain the name of that particular academician. In an instance, the secondary address from where the webpage of “Ram Kumar” is found will contain the addresses having words Ram Kumar. Apart from this, the dedicated academician address may also contain words like view profile, view biography, etc.

Before passing the corresponding webpage to classifying unit, a check is applied to decide if string presents in the secondary address represent the name of a person or not. One way of doing this is to create a huge dataset of names and then applying search for the existence of a string in that dataset. The other solution could be having a trained machine learning system to classify the strings as name or not name. This approach seems to be the best solution to this complicated problem. But, the crawler will encounter people with new names all the time, so manually updating the datasets everytime for a new name cannot be a solution.

Many existing string databases were explored and the best suitable found for this particular problem was English dictionary. Let us consider the name “Narendra Modi”. It comprises of two words Narendra and Modi, both of which are not found in English dictionary. Consider yet another name, “Robin Gautam”. The word “Robin” can be found in the dictionary as a species of birds but the surname “Gautam” is not present in the dictionary.

This pattern was sensed and used for deciding if the address and corresponding set of secondary addresses passed by the distiller actually represents a person's webpage or not. The string is split through white spaces and presence of each subpart in dictionary is checked. The absence of any part in dictionary hints that the string is a name. This method may fail at times but can give good results and avoid the need for manual addition of words as required in other methods. Further, to validate the effectiveness of this method names dataset provided by the social security Administration US (Administration 2016), under national data was used. Around 93% of the names were correctly identified. This proves to be a promising approach in name determination. The names it failed to check are the ones that comprise of English dictionary words.

But the project under consideration has one more open end, it was required to find specifically the Indian academicians (although proposed technique can be applied to any nationality academicians). To do this task, three keyword databases: Indian surname database, Indian premier institute name database and Indian cities having 5800, 2000 and 275 entries respectively were used. Along with this, a dataset of 1700 webpages from 26 countries is used for the training purpose. The training set consist of 1700 randomly selected examples both relevant and irrelevant from 26 countries whose seed addresses have been collected.

As indicated in FIG. 5, the addresses are passed from the distiller and various filtering techniques are applied. The corresponding webpage is extracted and stopwords are eliminated. If the probability is above a threshold the webpage is marked as relevant i.e. being of an Indian origin academician, the set of secondary addresses is extracted. Otherwise, the webpage is ignored and control is transferred to the next webpage.

Table 1(a) below shows the percentage accuracy obtained by implementing so disclosed Naïve Bayes protocol based focused web crawling system and method. Accuracy is measured to inform how correctly the crawler can classify webpages of Indian origin academicians, wherein the results are presented in the form of a confusion matrix. As the number of classes is two i.e. relevant or irrelevant, so confusion matrix has two dimensions. Rows of confusion matrix represent the actual classification and columns denote the classification as predicted by the present system and method.

TABLE 1(a)

Accuracy (in percentage)

| Protocol | Training | Testing |
|---|---|---|
| KNN | 100.0 | 89.6 ± 0.78 |
| SVM | 92.0 | 91.2 ± 0.53 |
| NB | 85.0 | 84.4 ± 0.70 |
| Decision tree | 87.2 | 87.0 ± 0.65 |
| Naïve Bayes Protocol | 94.3 | 92.0 ± 0.53 |

Furthermore, Table 1(b) below shows the Average Cost obtained by implementing so disclosed naive bayes protocol based focused web crawling system and method. The cost matric can have different definitions in other scenarios. Classification cost has been used here, wherein the cost involves giving a reward for every correct classification and penalties for misclassification of the webpage. For the cost matrix, pᵢⱼ represents the penalty for misclassifying an example in class i to j. The total cost of the algorithm is calculated by the sum Σ confusion matrix×cost matrix. Only average cost has been represented for the task i.e. (total cost)/number of elements in confusion matrix.

TABLE 2

Average cost

| Protocol | Training | Testing |
|---|---|---|
| KNN | 0 | 0.578 ± 1.03 |
| SVM | 0.873 | 0.88 ± 1.00 |
| NB | 0.517 | 0.589 ± 0.69 |
| Decision tree | 0.261 | 0.638 ± 1.47 |
| Naïve Bayes Protocol | 0.201 | 0.274 ± 1.06 |

For constructing above two tables, the dataset was split into train/test sets. Cross-validation has been used in which data was divided into k subsamples and remaining (n−1) subsamples are used for constructing the rules. The accuracy is calculated by using an average of n subsamples. This method is heavy on resources but gives highly accurate results.

Referring to Table 1a and 1b, the measure of accuracy and cost is shown respectively for K Nearest Neighbours (KNN), Support Vector Machines (SVM), Naïve Bayes (NB), Decision tree and Naïve Bayes Protocol (NBP). The standard deviation in both tables is calculated using \sqrt{v(1−v)/N}, where v is the measured value and N is the number of webpages in test dataset. KNN and SVM methods perform well in terms of accuracy. The prime reason for the success of these methods maybe because of the features selected for these methods is relevant and related to each other. NB and decision tree perform moderately for accuracy. The Naïve Bayes Protocol (NBP) gives best performance in case of test data. Due credit in this case should be given to the procedure that filters out the addresses early and makes it not only simple but efficient as well. This is also the reason that the cost is lowest for Naïve Bayes Protocol in table 1b. Cost for SVM is highest as it tries to maximize the accuracy and not cost.

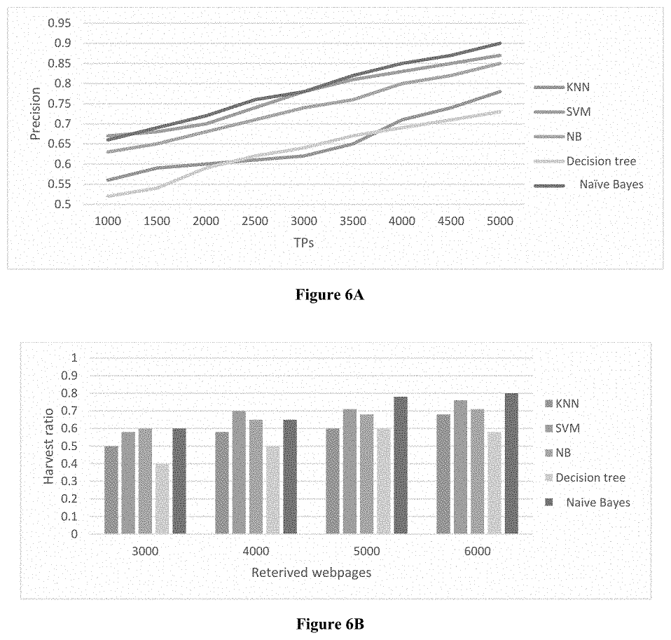

FIG. 6A shows an experimental performance chart of precision versus true positive for disclosed Naïve Bayes protocol in comparison to other state-of-the-art protocols. Further, the proposed crawler was tested on open web to get the webpages of Indian origin academicians from foreign university websites by varying True Positives (TP) in the training set. After training with varying TPs, seed addresses from different country academic websites are provided. As the number of true positive is increased the performance of plurality of compared methods also improves. NBP performed best in the scenario and SVM and NB also performed well.

Referring to FIG. 6B, an experimental performance chart of harvest ratio versus retrieved webpages for disclosed Naïve Bayes protocol in comparison to other state-of-the-art protocols has been presented. Harvest ratio is the measure at which relevant webpages are acquired and irrelevant webpages are filtered off from crawling. The present invention which included Naïve Bayes Protocol outer performs in each case as the irrelevant addresses are filtered out at the initial stage. Further distance to relevant webpages is reduced with each step and chances of crawler getting skewed is very less.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “includes” and “including” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

I/We claim:

1) A system for focused web crawling, comprising:
a crawler configured to extract addresses of plurality of webpages similar to a receivable at least one seed address;
a distiller configured to sequentially refine said addresses using plurality of filtration techniques and naïve bayes protocol, thereby transferring a first set of relevant addresses for being iteratively passed onto said crawler; and
a classifying module operable to categorize said plurality of webpages for relevancy via said protocol; thereafter deriving a second set of relevant addresses for being iteratively passed onto said distiller,
wherein said crawler retrieves said plurality of webpages as well as addresses associated with said plurality of webpages;
wherein said system further comprises of a queuing unit for maintaining at least one list of said addresses extracted from said crawler;
wherein said queuing unit strategically updates said list based on sequential inputs received from said crawler;
wherein said classifying module formulates an intelligence matrix from a training unit configured to conceptualize said relevancy; and
wherein said training unit further includes a keyword extraction unit containing a list of keywords to be analyzed therein for said conceptualization.

2) The focused web crawling system as claimed in claim 1, wherein front address from said first set of relevant addresses is passed onto said crawler.

3) The focused web crawling system as claimed in claim 1, wherein said crawler also maintains a crawling history that includes but not limited to crawled part of said plurality of webpage, time taken to download a file, number of said iterations.

4) The focused web crawling system as claimed in claim 1, wherein said plurality of filtration techniques are selected to be but not limited to checking top level domain of said addresses, checking no out of domain address, checking duplicity in already processed addresses, checking duplicity in yet to be processed addresses, discarding addresses based on irrelevant keywords.

5) The focused web crawling system as claimed in claim 1, wherein said training unit conducts procedures including but not restricted to stopword elimination, stemming, generation of set of features based on occurrence frequency, implementation of said naïve bayes protocol.

6) The focused web crawling system as claimed in claim 5, wherein said training unit further shortlists said set of features using approaches including but not limited to document frequency approach, information gain approach, chi-square statistics approach, term strength approach.

7) The focused web crawling system as claimed in claim 1, wherein said classifying module categorizes said plurality of webpages by comparing said intelligence matrix.

8) A method to implement focused web crawling, comprising steps of:
inputting a seed address into a subsequently formed address queue;
iteratively extracting a primary address from said address queue;
iteratively invigilating said primary address for presence in an address store;
if not present, extracting set of secondary addresses from webpage of said primary address;
applying plurality of filtering techniques as a passing criteria on said set of secondary addresses;
if passed, verifying said set of secondary addresses for presence of a set of predefined keywords;
upon successful verification, classifying said set of secondary addresses for relevancy via naive bayes protocol;
transferring relevant set of secondary addresses into said address queue, else into said address store;
simultaneously calculating primary conditional probability of a set of predefined webpage(s) using said protocol;
sequentially calculating plurality of secondary conditional probabilities pertaining to said webpage(s) of said iteratively extracted primary addresses;
classifying said webpage(s) having said secondary conditional probability higher than said primary conditional probability as relevant webpage(s), else irrelevant webpage(s); and
transferring addresses of said relevant webpage(s) into said address queue, else into said address store.

9) The method to implement focused web crawling as claimed in claim 7, wherein said primary address is preferably front address in said address queue.

10) The method to implement focused web crawling as claimed in claim 7, wherein said plurality of filtration techniques are selected to be but not limited to checking top level domain of said addresses, checking no out of domain address, checking duplicity in already processed addresses, checking duplicity in yet to be processed addresses, discarding addresses based on irrelevant keywords.

11) The method to implement focused web crawling as claimed in claim 7, wherein calculation of said secondary conditional probability is supported by plurality of preliminary procedures including but not restricted to stopword elimination, stemming, generation of set of features based on occurrence frequency.

12) The method to implement focused web crawling as claimed in claim 7, wherein classification of said relevant set of secondary addresses and addresses of said relevant webpage(s) occurs concurrently.
